(19) United States
(12) Patent Application Publication
(10) Pub. No.: US 2025/0350041 A1
(43) Pub. Date: Nov. 13, 2025

(54) STRUCTURE FOR CRIMPING WIRE AND OUTER CONDUCTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shohei TAKEGASA, Osaka (JP); Kazuaki HAMADA, Osaka (JP); Tatsuki SATOOKA, Osaka (JP)

(21) Appl. No.: 18/862,551

(22) PCT Filed: Apr. 18, 2023
(86) PCT No.: PCT/JP2023/015407

§ 371 Date: Nov. 4, 2024

(30) Foreign Application Priority Data
May 9, 2022 (JP) 2022-077041

(51) Int. Cl. H01R 4/18; H01R 13/6592

(52) U.S. Cl. CPC H01R 4/183; H01R 13/6592

(57) ABSTRACT

This structure for crimping an electric wire and an outer conductor comprises an open-barrel crimping portion (25) which is provided on an outer conductor (16) to be connected to an end of a shield electric wire (10), and which is crimped on an outer periphery of the shield electric wire (10). The crimping portion (25) includes a substrate portion (26), a plurality of extending portions (28), and a plurality of claw portions (30). The substrate portion (26) is disposed so as to surround the outer periphery of the shield electric wire (10). The extending portions (28) extend in a cantilevered fashion from the rear edge of the substrate portion (26) rearward in the axial direction of the shield electric wire (10), and are disposed side by side in the circumferential direction of the shield electric wire (10). The plurality of claw portions (30) are formed by bending the rear end of the respective extending portions (28) inward in the radial direction of the shield electric wire (10), and dig into the outer surface of a sheath (14) of the shield electric wire (10). Between the claw portions (30) that are adjacent to each other in the circumferential direction, the side edges of the claw portions (30) that extend along the radial direction and are opposed to each other are displaced in the axial direction.

### TECHNICAL FIELD

The present disclosure relates to a structure for crimping a wire and an outer conductor.

### BACKGROUND

Patent Document 1 discloses a structure for fixing an outer conductor and a shield wire by providing a protrusion projecting radially inward on a rear end part of the outer conductor and causing this protrusion to bite into an outer sheath of the shield wire.

### PRIOR ART DOCUMENT

### Patent Document

Patent Document 1: JP 2018-147564 A

### SUMMARY OF THE INVENTION

### Problems to be Solved

It is known to further enhance a fixing force of the outer conductor and the shield wire by increasing the number of protrusions. However, if the number of the protrusions is increased, there is a concern of increasing a chance of mutual interference of the protrusions adjacent in a circumferential direction. Thus, a method has been desired which more firmly fixes the outer conductor and the shield wire while suppressing the chance of mutual interference of the adjacent protrusions.

The present disclosure was completed on the basis of the above situation and aims to firmly fix an outer conductor and a shield wire.

### Means to Solve the Problem

The present disclosure is directed to a structure for crimping a wire and an outer conductor, the structure including a crimping portion provided in the outer conductor to be connected to an end part of the wire, the crimping portion being in the form of an open barrel to be crimped to an outer periphery of the wire, the crimping portion including a base plate portion arranged to surround the outer periphery of the wire, a plurality of extending portions arranged side by side in a circumferential direction of the wire while being cantilevered rearward in an axial direction of the wire from a rear edge of the base plate portion, and a plurality of claw portions formed by bending rear end parts of the respective extending portions radially inward of the wire, the plurality of claw portions biting into an outer surface of the wire, and side edges of the claw portions extending along a radial direction and facing each other being shifted in the axial direction between the claw portions adjacent in the circumferential direction.

### Effect of the Invention

According to the present disclosure, it is possible to firmly fix an outer conductor and a shield wire.

### BRIEF DESCRIPTION OF THE DRAWINGS

FIG. 1 is a side view of a shield conductive path of a first embodiment.

FIG. 2 is a side view in section of the shield conductive path of the first embodiment.

FIG. 3 is a section along A-A in FIG. 1.

FIG. 4 is a partial development of an outer conductor of the first embodiment.

FIG. 5 is a partial development of an outer conductor of a second embodiment.

FIG. 6 is a partial side view of a shield conductive path of the second embodiment.

FIG. 7 is a section along B-B in FIG. 6.

FIG. 8 is a partial development of a shield conductive path of another embodiment.

### DETAILED DESCRIPTION TO EXECUTE THE INVENTION

### Description of Embodiments of Present Disclosure

First, embodiments of the present disclosure are listed and described below.

(1) The structure for crimping a wire and an outer conductor of the present disclosure includes a crimping portion provided in the outer conductor to be connected to an end part of the wire and in the form of an open barrel to be crimped to an outer periphery of the wire. The crimping portion includes a base plate portion, a plurality of extending portions and a plurality of claw portions. The base plate portion is arranged to surround the outer periphery of the wire. The plurality of extending portions are arranged side by side in a circumferential direction of the wire while being cantilevered rearward in an axial direction of the wire from a rear edge of the base plate portion. The plurality of claw portions are formed by bending rear end parts of the respective extending portions radially inward of the wire, and bite into an outer surface of the wire. Side edges of the claw portions extending along a radial direction and facing each other are shifted in the axial direction between the claw portions adjacent in the circumferential direction. According to this configuration, since the side edges of the claw portions facing each other in the circumferential direction are shifted in the axial direction between the claw portions adjacent in the circumferential direction, the mutual interference of the adjacent claw portions can be avoided even without thinning projecting end parts of the claw portions. Since the tips of the wide claw portions can bite into the outer surface of the wire in this way, the outer conductor and the wire can be firmly fixed.

(2) Preferably, the claw portion is bent along a fold in the circumferential direction, and the folds of the extending portions adjacent in the circumferential direction are arranged and shifted in the axial direction. According to this configuration, the mutual interference of the adjacent claw portions can be avoided by a simple configuration of shifting the folds of the adjacent extending portions in the axial direction, whereby the tips of the respective claw portions can bite into the outer surface of the wire without being thinned.

(3) Preferably, in (2), a through hole penetrating in the radial direction is formed in a rear edge part of the base plate portion, and a region where the through hole is formed, out of the rear edge of the base plate portion, protrudes rearward. The extending portions include first and second extending portions adjacent in the circumferential direction. A dimension of the first extending portion is larger than that of the second extending portion in the axial direction. The first extending portion is arranged in the region where the through hole is formed, out of the rear edge of the base plate portion, and the second extending portion is arranged in a region where the through hole is not formed, out of the rear edge of the base plate portion. According to this configuration, out of the rear edge of the base plate portion, a position where the first extending portion having a large axial dimension extends is set behind a position where the second extending portion having a small axial dimension extends, the interference of the claw portion of the first extending portion and that of the second extending portion can be prevented.

(4) Preferably, in (1), the claw portion is bent along a fold in a direction oblique to both the axial direction and the circumferential direction, and the folds adjacent in the circumferential direction are aligned in position in the axial direction. According to this configuration, since the folds adjacent in the circumferential direction are aligned in position in the axial direction, the mutual interference of the adjacent claw portions can be avoided and appearance can be improved.

### DETAILS OF EMBODIMENTS OF PRESENT DISCLOSURE

### First Embodiment

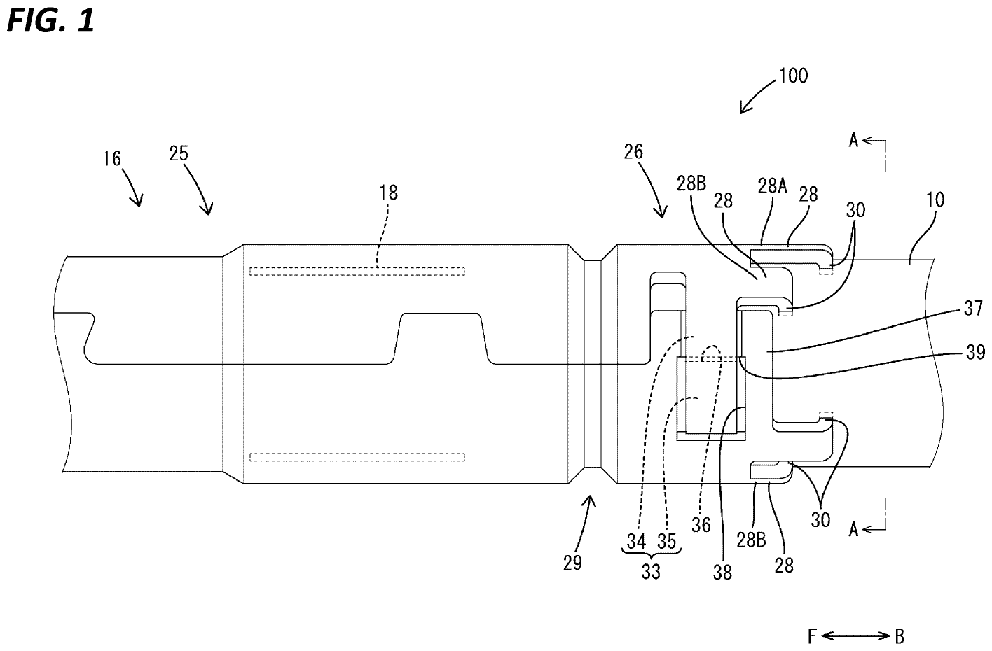

A first specific embodiment of the present disclosure is described with reference to FIGS. 1 to 4. In figures, a “front side” and a “rear side” are respectively represented by “F” and “B”.

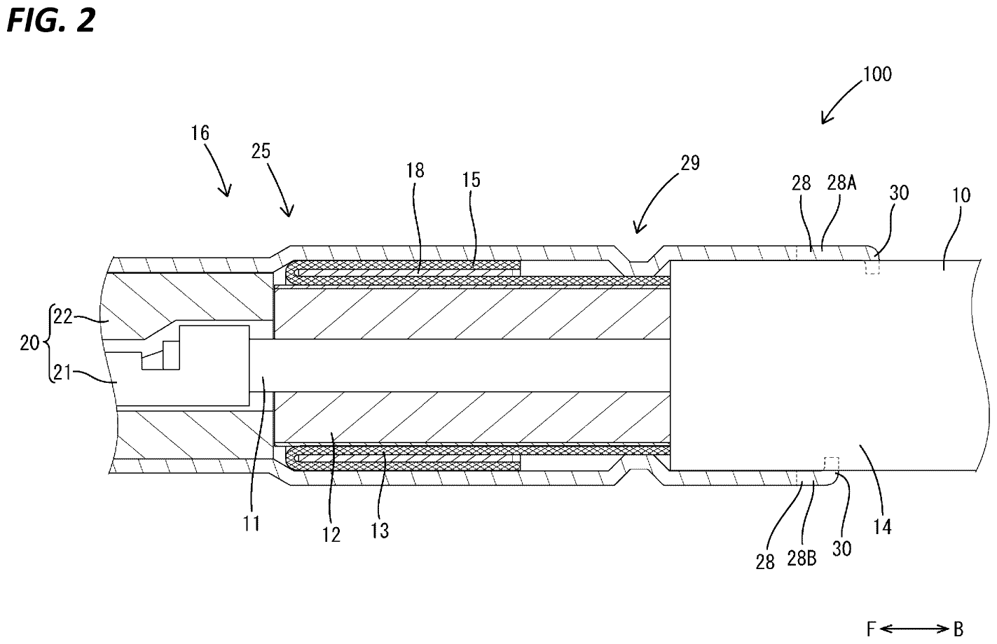

A structure for crimping a wire and an outer conductor of the first embodiment is applied to a shield conductive path 100. As shown in FIGS. 1 and 2, the shield conductive path 100 is provided with a shield wire 10, a sleeve 18 externally fit to the shield wire 10, which is a wire, a shield terminal 20 connected to a front end part of the shield wire 10, and an outer conductor 16 to be connected to a tip part of the shield wire 10.

The shield wire 10 is arranged with an axial direction oriented in a front-rear direction. In the following description, the front-rear direction and the axial direction are used as synonyms. The shield wire 10 is formed such that a core wire 11 is surrounded by an insulation coating 12, a tubular shield layer 13 is overlapped on the outer periphery of the insulation coating 12, and the outer periphery of the shield layer 13 is surrounded by a sheath 14. The shield layer 13 is constituted by a braided wire. As shown in FIG. 2, the sheath 14 and the insulation coating 12 are removed and the core wire 11 is exposed forward of the insulation coating 12 in a front end part of the shield wire 10. The sheath 14 is removed behind the exposed core wire 11 to expose the shield layer 13.

The sleeve 18 is externally fit to the outer peripheral surface of the shield layer 13 exposed by removing the sheath 14. The sleeve 18 has a tubular shape. The sleeve 18 surrounds the shield layer 13 and the insulation coating 12. A front end part of the shield layer 13 is folded rearward and covers the outer periphery of the sleeve 18. A region of the shield layer 13 surrounding the sleeve 18 is defined as a folded portion 15. The front end of the sleeve 18 is located slightly rearward of the front end of the insulation coating 12. The rear end of the sleeve 18 is located forward of the front end of the sheath 14. The front end of the sheath 14 and the rear end of the sleeve 18 are separated in the axial direction.

The shield terminal 20 includes an inner conductor 21 connected to a front end part of the core wire 11 and a dielectric 22 accommodating the inner conductor 21. The inner conductor 21 is crimped to the front end part of the core wire 11. The inner conductor 21 and the dielectric 22 are accommodated in the outer conductor 16 to be described later.

The outer conductor 16 includes a crimping portion 25. The crimping portion 25 is a part for fixing the outer conductor 16 to the outer peripheral surface of the shield wire 10 by being crimped to the outer periphery of the shield wire 10. By crimping the crimping portion 25 to the shield wire 10, a front end part of the shield wire 10 and a rear end part of the shield terminal 20 are connected while being restricted from being separated in the axial direction, and the outer conductor 16 and the shield layer 13 are conductively connected. The crimping portion 25 is formed with a retaining portion 29 extending in a circumferential direction of the shield wire 10 (see FIG. 1) (hereinafter, the circumferential direction of the shield wire 10 is also merely referred to as a circumferential direction). The retaining portion 29 is shaped by striking a part of the crimping portion 25 radially inwardly. With the crimping portion 25 crimped to the shield wire 10, the retaining portion 29 is entirely continuous in the circumferential direction.

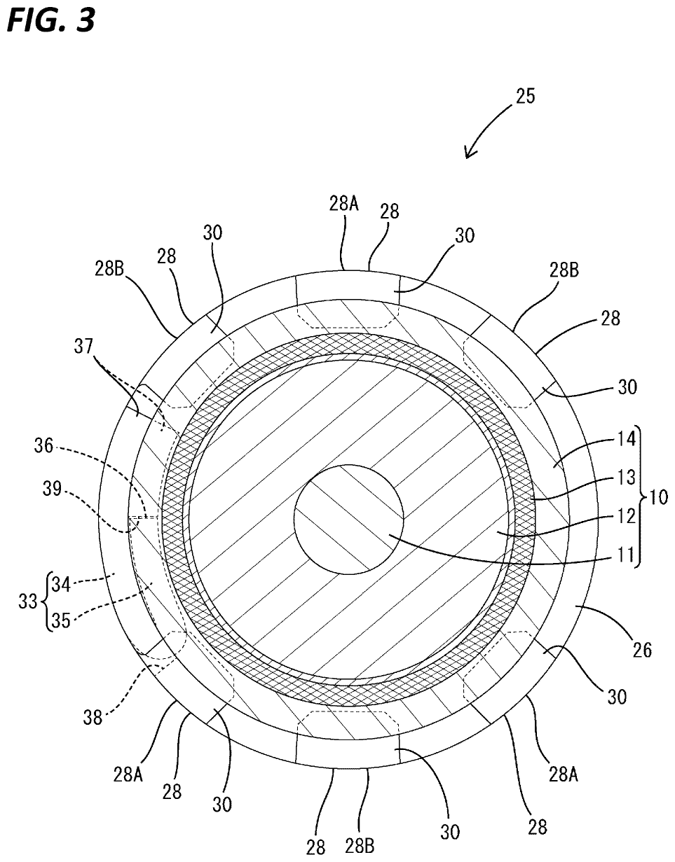

As shown in FIG. 3, the crimping portion 25 includes a base plate portion 26, a plurality of extending portions 28 and a plurality of claw portions 30. The base plate portion 26 is provided behind the retaining portion 29 (see FIG. 1). In a state before the crimping portion 25 is crimped to the shield wire 10, the base plate portion 26 is in the form of a so-called open barrel by being cut in a circumferential part along the axial direction. With the crimping portion 25 crimped to the shield wire 10, the base plate portion 26 is formed into an annular shape with a cut-open part closed, and arranged to surround the outer periphery of the shield wire 10. The base plate portion 26 is provided with an outer peripheral side locking portion 33 and an inner peripheral side locking portion 37.

The outer peripheral side locking portion 33 extends in one circumferential direction to cross over the cut-open part of the base plate portion 26 (see FIG. 1). The outer peripheral side locking portion 33 includes a base portion 34 flush with and extending from the base plate portion 26 and a locking protrusion 35 folded radially inward from the projecting end of the base portion 34. The locking protrusion 35 is arranged to overlap the inner surface of the base portion 34, and located radially inward of the base portion 34. The locking protrusion 35 projects radially inward from the base plate portion 26. The locking protrusion 35 has a first locking surface 36 facing in a direction opposite to a projecting direction of the base portion 34 in the circumferential direction.

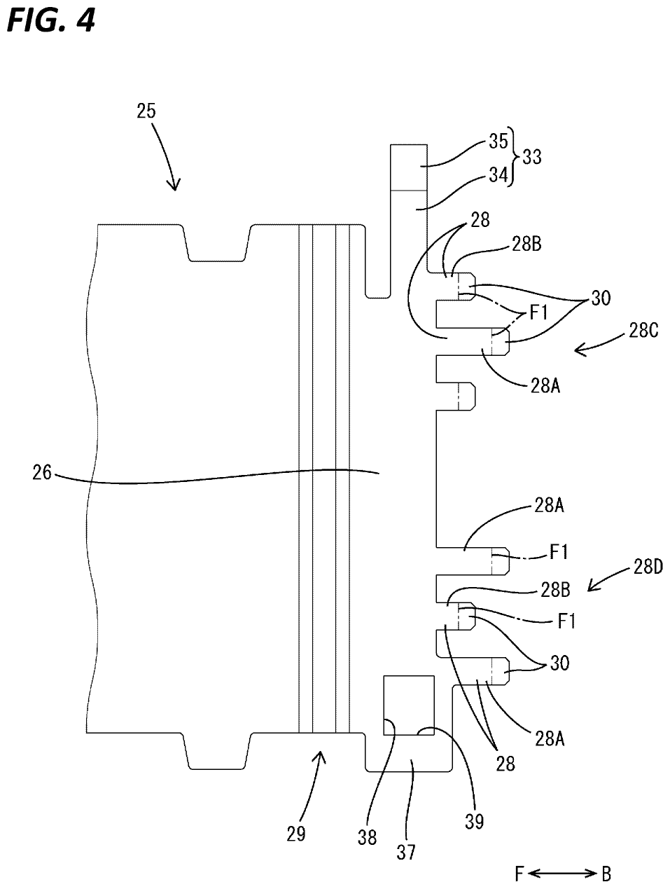

The inner peripheral side locking portion 37 extends in a direction opposite to the outer peripheral side locking portion 33, i.e. in the other circumferential direction (see FIG. 1). A rectangular through hole 38 penetrating in a plate thickness direction (radial direction) is formed side by side with the inner peripheral side locking portion 37 in the circumferential direction on a rear edge part of the base plate portion 26 (see FIG. 1). Out of the inner peripheral surface along the opening edge of the through hole 38, an inner surface parallel to the axial direction and on a side near the inner peripheral side locking portion 37 in the circumferential direction functions as a second locking surface 39, to which the facing first locking surface 36 of the locking protrusion 35 is locked. Out of the rear edge of the base plate portion 26, a region where the inner peripheral side locking portion 37 and the through hole 38 are formed protrudes more rearward than a part where the inner peripheral side locking portion 37 and the through hole 38 are not formed (see FIG. 4).

As shown in FIG. 4, the plurality of extending portions 28 are cantilevered rearward in the axial direction from the rear edge of the base plate portion 26. The extending portions 28 include first extending portions 28A and second extending portions 28B. In the axial direction, a dimension of the first extending portion 28A is larger than that of the second extending portion 28B. The first and second extending portions 28A, 28B (plurality of extending portions 28) are adjacently and alternately arranged side by side in the axial direction (the circumferential direction corresponds to the vertical direction in FIG. 4). Specifically, the second extending portion 28B is arranged on a part of the rear end edge of the base plate portion 26 where the base end of the outer peripheral side locking portion 33 is located, and the first extending portion 28A is arranged on a part of the rear end edge of the base plate portion 26 where the base end of the inner peripheral side locking portion 37 is located. The first extending portion 28A is arranged, but the second extending portion 28B is not arranged in a region where the through hole 38 is formed, out of the rear edge of the base plate portion 26. The first extending portions 28A and the second extending portions 28B are arranged in a region where the inner peripheral side locking portion 37 and the through hole 38 are not formed, out of the rear edge of the base plate portion 26.

On the rear end edge of the base plate portion 26, the extending portions 28 are arranged to be biased to two locations on the side of the outer peripheral side locking portion 33 and on the side of the inner peripheral side locking portion 37. In other words, the extending portions 28 are separately arranged at two locations, i.e. on the side of the outer peripheral side locking portion 33 and on the side of the inner peripheral side locking portion 37. Specifically, a one-side extending portion 28C composed of two second extending portions 28B and one first extending portion 28A is arranged on the side of the outer peripheral side locking portion 33 on the rear end edge of the base plate portion 26. In the one-side extending portion 28C, the one first extending portion 28A is arranged between the two second extending portions 28B in the circumferential direction.

An other-side extending portion 28D composed of one second extending portion 28B and two first extending portions 28A is arranged on the side of the inner peripheral side locking portion 37 on the rear end edge of the base plate portion 26. In the other-side extending portion 28D, the one second extending portion 28B is arranged between the two first extending portions 28A in the circumferential direction. That is, the first and second extending portions 28A, 28B are alternately arranged adjacent to each other in the circumferential direction. In the one-side extending portion 28C and the other-side extending portion 28D, dimensions between the extending portions 28 adjacent in the circumferential direction are equal to a dimension in a width direction (circumferential direction) of each extending portion 28. A dimension in the circumferential direction between the one-side extending portion 28C and the other-side extending portion 28D is larger than the dimensions between the extending portions 28 adjacent in the circumferential direction in the one-side extending portion 28C and the other-side extending portion 28D. A carrier is, for example, coupled to the rear end edge of the base plate portion 26 between the one-side extending portion 28C and the other-side extending portion 28D.

The plurality of claw portions 30 are provided by bending rear end parts of the respective extending portions 28 radially inward (see FIGS. 1 and 2). Specifically, each claw portion 30 is bent along a fold F1 extending in the circumferential direction. Both end edges in the circumferential direction of each claw portion 30 are parallel to each other and extend along the radial direction (see FIG. 3). The tip edge (rear end edge) of each claw portion 30 is formed to be parallel to the fold F1. That is, the tip edge (rear end edge) of each claw portion 30 extends in the circumferential direction. In a tip part of each claw portion 30, both end parts in the circumferential direction are chamfered (C surfaces).

Dimensions in the radial direction (projecting dimension) of the respective claw portions 30 are equal. In other words, the respective claw portions 30 project radially inward the same dimension from the inner surfaces of the respective extending portions 28 (see FIG. 3). The folds F1 of the extending portions 28 adjacent in the circumferential direction are shifted in the axial direction (see FIG. 4). These claw portions 30 bite into the outer surface of the sheath 14 of the shield wire 10 by crimping the crimping portion 25 to the shield wire 10 (see FIGS. 2 and 3). In this way, the outer conductor 16 is suppressed from moving in the axial direction or rotating in the circumferential direction with respect to the shield wire 10. Side edges of the claw portions 30 extending in the radial direction and facing each other are shifted in the axial direction between the claw portions 30 adjacent in the circumferential direction (see FIG. 1).

A crimping process of crimping the crimping portion 25 to the shield wire 10 is performed with the crimping portion 25 and the front end part of the shield wire 10 set in an applicator (not shown). In the crimping process, the base plate portion 26 is deformed and contracted in diameter and crimped to wind around the outer periphery of the shield wire 10. With the crimping portion 25 crimped to the shield wire 10, a region of the crimping portion 25 in front of the retaining portion 29 is crimped to the outer peripheral surfaces of the sleeve 18 and the folded portion 15 and the folded portion 15 is sandwiched in the radial direction between the sleeve 18 and the crimping portion 25 (see FIG. 2). In this way, the folded portion 15, the sleeve 18 and the crimping portion 25 are conductively fixed while being integrated.

With the crimping portion 25 crimped to the shield wire 10, the retaining portion 29 is arranged between the front end of the sheath 14 and the rear end of the sleeve 18 (see FIG. 2). The outer peripheral side locking portion 33 crosses over the cut-open part of the base plate portion 26 and the locking protrusion 35 is accommodated into the through hole 38 (see FIG. 3). For example, when the crimping process is performed, the inner peripheral side locking portion 37 in contact with the inner surface of the base portion 34 is pressed radially inward via the base portion 34. In this way, the inner peripheral side locking portion 37 in contact with the inner surface of the base portion 34 is deformed to be recessed radially inward (see FIG. 3). In this way, the first and second locking surfaces 36, 39 are facing each other in the circumferential direction, come into contact and are locked (see FIGS. 1 and 3). By the locking of the first and second locking surfaces 36, 39, the crimping portion 25 is prevented from being opened in the circumferential direction, and held in a state fixed to the outer periphery of the shield wire 10.

When the crimping portion 25 is crimped to the shield wire 10, the respective claw portions 30 are pressed radially inward and bite into the outer surface of the sheath 14 while intervals between the claw portions 30 adjacent in the circumferential direction are narrowed. The claw portions 30 adjacent in the circumferential direction are shifted in the axial direction. Thus, the respective claw portions 30 do not contact each other in the circumferential direction even if the intervals between the claw portions 30 adjacent in the circumferential direction are narrowed.

Next, functions of the first embodiment are described.

The structure for crimping a wire and an outer conductor of the present disclosure includes the crimping portion 25 provided in the outer conductor 16 to be connected to the end part of the shield wire 10 and in the form of an open barrel to be crimped to the outer periphery of the shield wire 10. The crimping portion 25 includes the base plate portion 26, the plurality of extending portions 28 and the plurality of claw portions 30. The base plate portion 26 is arranged to surround the outer periphery of the shield wire 10. The plurality of extending portions 28 are arranged side by side in the circumferential direction of the shield wire 10 while being cantilevered rearward in the axial direction of the shield wire 10 from the rear edge of the base plate portion 26. The plurality of claw portions 30 are formed by bending the rear end parts of the respective extending portions 28 radially inward of the shield wire 10, and bite into the outer surface of the sheath 14 of the shield wire 10. The side edges of the claws 30 extending along the radial direction and facing each other are shifted in the axial direction between the claw portions 30 adjacent in the circumferential direction. According to this configuration, since the side edges of the claw portions 30 facing each other in the circumferential direction are shifted in the axial direction between the claw portions 30 adjacent in the circumferential direction, the mutual interference of the adjacent claw portions 30 can be avoided even without thinning projecting end parts of the claw portions 30. Since the tips of the wide claw portions 30 can bite into the outer surface of the shield wire 10 in this way, the outer conductor 16 and the shield wire 10 can be firmly fixed.

The claw portion 30 is bent along the fold F1 in the circumferential direction, and the folds F1 of the extending portions 28 adjacent in the circumferential direction are shifted in the axial direction. According to this configuration, the mutual interference of the adjacent claw portions 30 can be avoided by a simple configuration of shifting the folds F1 of the adjacent claw portions 30 in the axial direction, whereby the tips of the respective claw portions 30 can bite into the outer surface of the shield wire 10 without being thinned.

The through hole 38 penetrating in the radial direction is formed in the rear edge part of the base plate portion 26 and, out of the rear edge of the base plate portion 26, the region where the through hole 38 is formed protrudes rearward. The extending portions 28 include the first extending portions 28A and the second extending portions 28B adjacent in the circumferential direction. In the axial direction, the dimension of the first extending portion 28A is larger than that of the second extending portion 28B. The first extending portion 28A is arranged in the region where the through hole 38 is formed, out of the rear edge of the base plate portion 26, and the second extending portions 28B are arranged in a region where the through hole 38 is not formed, out of the base plate portion 26. According to this configuration, out of the rear edge of the base plate portion 26, a position where the first extending portion 28A having a large axial dimension extends is set behind a position where the second extending portions 28B having a small axial dimension extends. In this way, the interference of the claw portion 30 of the first extending portion 28A and those of the second extending portions 28B can be prevented.

### Second Embodiment

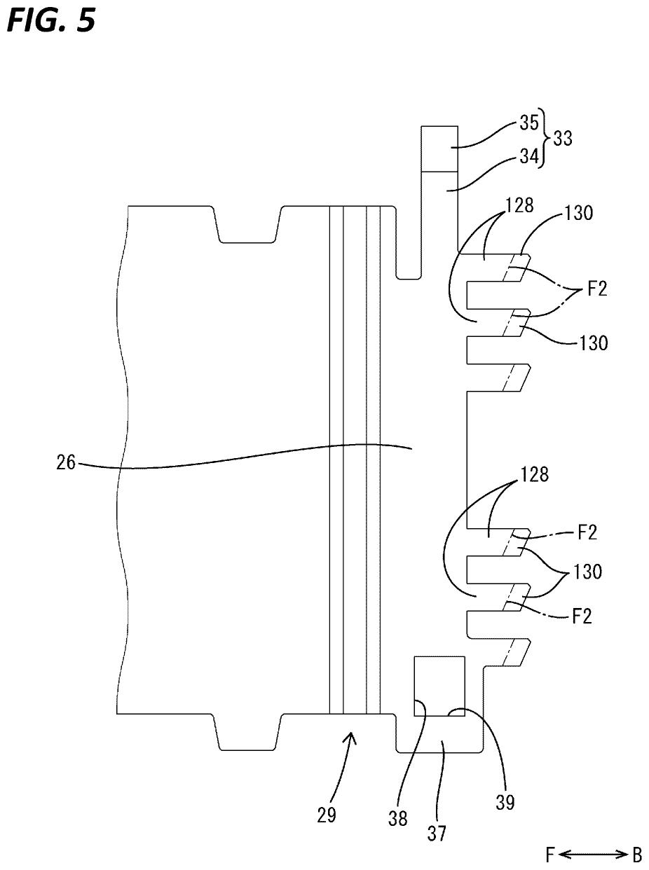

A second specific embodiment of the present disclosure is described with reference to FIGS. 5 to 7. A shield conductive path 200 having a structure for crimping a wire and an outer conductor of the second embodiment differs from the first embodiment in extension directions of folds F2. Since the other configuration is the same as in the first embodiment, the same components are denoted by the same reference signs and the structures, functions and effects thereof are not described. In figures, a “front side” and a “rear side” are respectively represented by “F” and “B”.

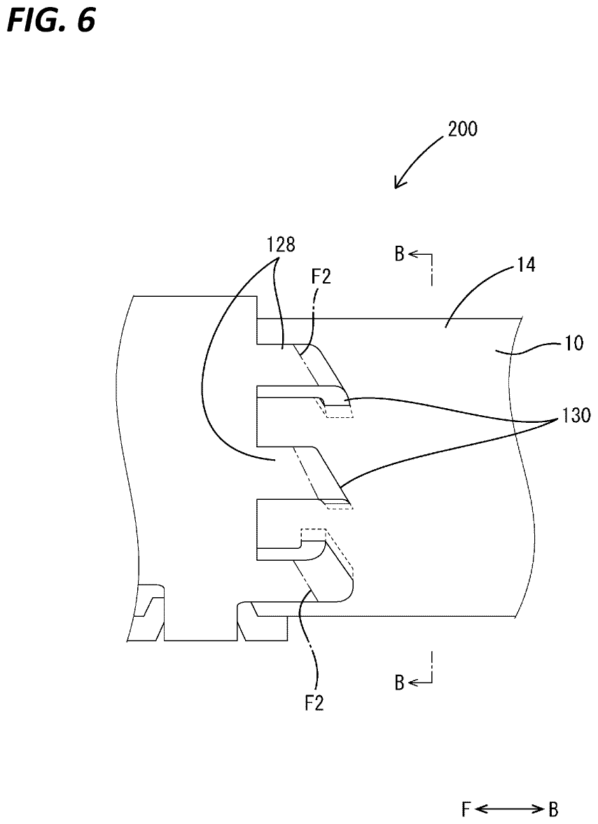

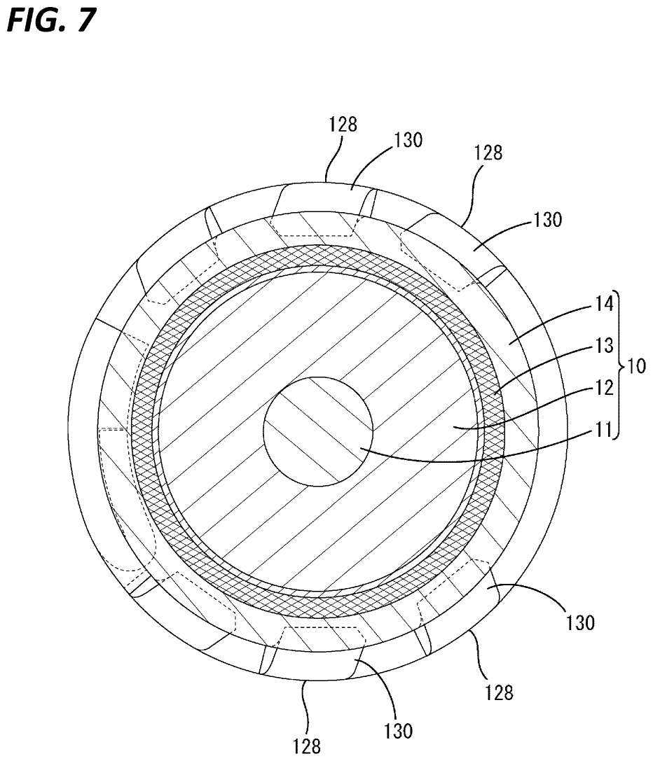

As shown in FIG. 5, dimensions in the axial direction of a plurality of extending portions 128 are equal. The fold F2 extends in a direction obliquely intersecting both the axial direction and a circumferential direction. The folds F2 adjacent in the circumferential direction are aligned in position in the axial direction. In other words, the positions of the plurality of folds F21 are arranged in a row in the circumferential direction while being aligned in the axial direction. The tip edge (rear end edge) of each claw portion 130 is formed to be parallel to the fold F2. Each claw portion 130 is bent along the fold F2 in the direction oblique to both the axial direction and the circumferential direction (see FIG. 6). As shown in FIG. 7, the tip edge of each claw portion 130 extends in a direction along the circumferential direction when viewed from the axial direction.

The claw portion 130 is bent along the fold F2 in the direction oblique to both the axial direction and the circumferential direction, and the folds F2 adjacent in the circumferential direction are aligned in position in the axial direction. According to this configuration, since the folds F2 adjacent in the circumferential direction are aligned in position in the axial direction, the mutual interference of the adjacent claw portions 130 can be avoided and appearance can be improved.

### OTHER EMBODIMENTS

The present disclosure is not limited to the above described and illustrated embodiments, but is represented by claims. The present invention is intended to include all changes in the scope of claims and in the meaning and scope of equivalents and include also the following embodiments.

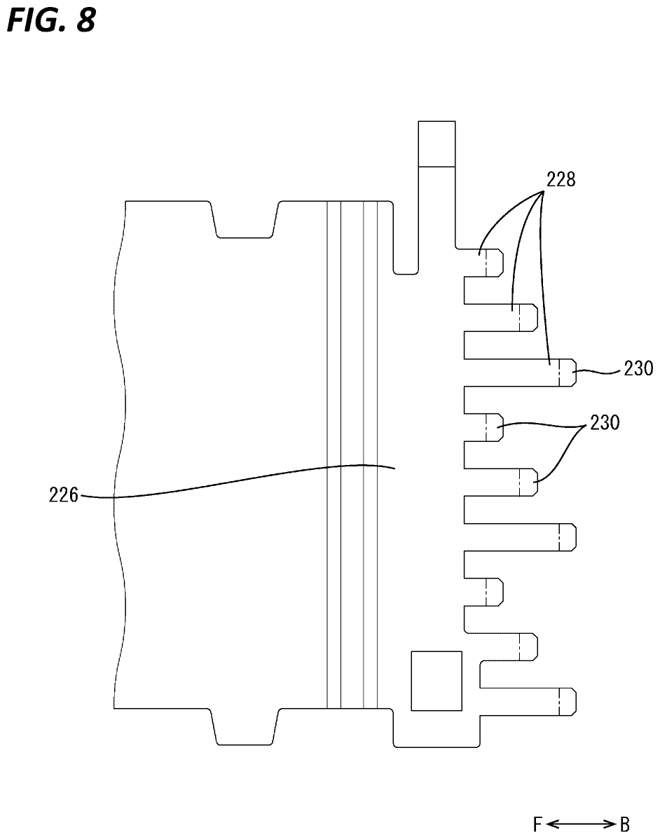

(1) Unlike the first and second embodiments, extending portions 228 having three different axial dimensions may be provided as shown in FIG. 8. In this case, a width in the circumferential direction of the extending portion 228 having a large axial dimension is preferably larger than that of the extending portion 228 having a small axial dimension. In this way, the extending portion 228 having the large axial dimension can be made difficult to deflect in the radial direction and a state where a claw portion 230 is biting in the sheath can be easily maintained.

(2) By increasing the width in the circumferential direction of the tip of the claw portion (i.e. by increasing a contact dimension of the tip of the claw portion in contact with the outer surface of the sheath), the outer conductor and the shield wire can be more firmly fixed. Thus, if the extending portions 228 are provided over the entire rear edge of a base plate portion 226 as shown in FIG. 8 unlike the first and second embodiments, the contact dimensions of the tips of the claw portions in contact with the outer surface of the sheath can be made larger and the outer conductor and the shield wire can be more firmly fixed.

(3) Unlike the first and second embodiments, the shield layer may be a metal foil.

List of Reference Numerals

| | |
|---|---|
| 10 | shield wire (wire) |
| 11 | core wire |
| 12 | insulation coating |
| 13 | shield layer |
| 14 | sheath |
| 15 | folded portion |
| 16 | outer conductor |
| 18 | sleeve |
| 20 | shield terminal |
| 21 | inner conductor |
| 22 | dielectric |
| 25 | crimping portion |
| 26, 226 | base plate portion |
| 28, 128, 228 | extending portion |
| 28A | first extending portion |
| 28B | second extending portion |
| 28C | one-side extending portion |
| 28D | other-side extending portion |
| 29 | retaining portion |
| 30, 130, 230 | claw portion |
| 33 | outer peripheral side locking portion |
| 34 | base portion |
| 35 | locking protrusion |
| 36 | first locking surface |
| 37 | inner peripheral side locking portion |
| 38 | through hole |
| 39 | second locking surface |
| 100, 200 | shield conductive path |
| F1, F2 | fold |

1. A structure for crimping a wire and an outer conductor, comprising a crimping portion provided in the outer conductor to be connected to an end part of the wire, the crimping portion being in the form of an open barrel to be crimped to an outer periphery of the wire,
the crimping portion including:
a base plate portion arranged to surround the outer periphery of the wire;
a plurality of extending portions arranged side by side in a circumferential direction of the wire while being cantilevered rearward in an axial direction of the wire from a rear edge of the base plate portion; and
a plurality of claw portions formed by bending rear end parts of the respective extending portions radially inward of the wire, the plurality of claw portions biting into an outer surface of the wire, and
side edges of the claw portions extending along a radial direction and facing each other being shifted in the axial direction between the claw portions adjacent in the circumferential direction.

2. The structure of claim 1, wherein:
the claw portion is bent along a fold in the circumferential direction, and
the folds of the extending portions adjacent in the circumferential direction are arranged and shifted in the axial direction.

3. The structure of claim 2, wherein:
a through hole penetrating in the radial direction is formed in a rear edge part of the base plate portion,
a region where the through hole is formed, out of the rear edge of the base plate portion, protrudes rearward,
the extending portions include first and second extending portions adjacent in the circumferential direction,
a dimension of the first extending portion is larger than that of the second extending portion in the axial direction,
the first extending portion is arranged in the region where the through hole is formed, out of the rear edge of the base plate portion, and
the second extending portion is arranged in a region where the through hole is not formed, out of the rear edge of the base plate portion.

4. The structure of claim 1, wherein:
the claw portion is bent along a fold in a direction oblique to both the axial direction and the circumferential direction, and
the folds adjacent in the circumferential direction are aligned in position in the axial direction.
